(19) United States
(12) Patent Application Publication
(10) Pub. No.: US 2003/0015672 A1
(43) Pub. Date: Jan. 23, 2003

(54) Methods and systems for alignment of detection optics

(75) Inventor: Steven J. Gallagher, Palo Alto, CA (US)

Correspondence Address: CALIPER TECHNOLOGIES CORP, 605 FAIRCHILD DRIVE, MOUNTAIN VIEW, CA, 94043, US

(73) Assignee: Caliper Technologies Corp., Mountain View, CA (US)

(21) Appl. No.: 10/197,231

(22) Filed: Jul. 16, 2002

Related U.S. Application Data
(60) Provisional application No. 60/306,094, filed on Jul. 17, 2001.

(51) Int. Cl. G01N 21/86

(52) U.S. Cl. 250/548

(57) ABSTRACT

The present invention provides methods and systems for aligning detection optics with a device by obtaining an optical profile of the system and comparing it with a preprogrammed layout of the various optical features of the device. The invention also provides methods of identifying devices by comparing the optical profile with a library of preprogrammed optical profiles of multiple devices.

### CROSS-REFERENCE TO RELATED APPLICATION

This application claims the benefit of U.S. Provisional Patent Application No. 60/306,094, filed Jul. 17, 2001, which is incorporated herein by reference in its entirety for all purposes.

### BACKGROUND OF THE INVENTION

Microfluidic systems are becoming increasingly popular for a wide variety of applications because of the several advantages they offer in comparison to conventional systems. Miniaturization of complex biochemical reactions, for instance, helps in reducing solvent usage, speed of reaction and throughput. Some of the high throughput systems are used for screening several potential candidates for therapeutic usage. High throughput microfluidic devices are described in detail in U.S. Pat. No. 6,046,056 which is incorporated in its entirety herein. The present invention relates generally to the use of microfluidic devices for performing chemical and biochemical analyses. Analysis of chemical and biochemical samples often requires detection and identification of the constituent elements. The microfluidic devices typically include multiple wells or reservoirs in fluid communication with microchannels whereby reactants placed in the wells are transported along the microchannels. This allows for “on chip” reactions followed by detection of end products within the same devices. A fully integrated microfluidic system will therefore generally include microfluidic devices that are coupled with several other components such as a material transfer system, a power source, and a detection system at a minimum.

Because of the small dimensions typically encountered with the use of microfluidic devices one of the challenges encountered in using these devices is the proper alignment of the detection system over the detection region of the device. Therefore, it becomes necessary to have systems with capabilities for proper positioning of the detector in reference to a targeted region of the microfluidic device.

The present invention serves this and other needs by providing methods and systems for alignment of detection optics in use with a microfluidic device.

### BRIEF SUMMARY OF THE INVENTION

The present invention provides improved microfluidic systems and methods of using these systems for performing laboratory analyses in a convenient and rapid format. In particular, the present invention provides methods and systems for aligning detection optics during use with microfluidic devices. In preferred aspects, the present invention provides a method whereby an optical profile of a microfluidic device is used to align the detection optics with a targeted region of the microfluidic device. This significantly simplifies the detection step during analysis and quantification of a reaction using a microfluidic device. In addition to providing methods for aligning the detection optics, the present invention provides devices with enhanced optical features whereby a distinct optical profile may be obtained for a particular device.

In another aspect, the invention provides methods for identification of microfluidic devices by virtue of the distinct optical profile associated with each device.

Although described in terms of microfluidic devices, those of skill in the art will appreciate the use of this invention with other devices such as multiwell plates, and the like.

### BRIEF DESCRIPTION OF THE DRAWINGS

FIG. 1 is an illustration of the layered fabrication of a typical microfluidic device, from at least two separate substrates, which substrates are mated together to define the microfluidic elements of the device.

FIG. 2 illustrates the use of an optical detection system with a microfluidic device.

FIG. 3 is a block diagram of a detector used in the method of the present invention.

FIG. 4 illustrates a layout used for a calculation of distances between two optical features of a device.

FIG. 5 illustrates an example of a device used with the methods of the present invention.

FIG. 6 illustrates optical profiles corresponding to two different microfluidic devices.

FIG. 7 is a flow chart of a software program or computer implemented process carried out for the performance of one of the methods of the present invention.

### DETAILED DESCRIPTION

The present invention is generally related to improved microfluidic systems and methods for their use in performing chemical and biochemical analyses of a sample.

Specifically, the present invention provides methods and systems for aligning the optical components of a detector over a region of a microfluidic device so as to improve the overall efficiency of the systems by improving the coordination of the various components. In preferred aspects the methods and systems of the instant invention are used in the detection of light-based signals from analytical systems employing optical detection in microscale fluidic channels. Examples of these include, e.g., fused silica capillary systems, i.e., CE, as well as microfluidic devices and systems that incorporate microscale channels such as microfluidic channels. Such systems are generally described in U.S. Pat. No. 5,976,336, the disclosure of each of which is hereby incorporated by reference in its entirety for all purposes.

I. Microfluidic Systems

As used herein, the terms “microscale” or “microfabricated” generally refers to structural elements or features of a device which have at least one fabricated dimension in the range of from about 0.1˜μm to about 500˜μm. Thus, a device referred to as being microfabricated or microscale will include at least one structural element or feature having such a dimension. When used to describe a fluidic element, such as a passage, chamber or conduit, the terms “microscale,” “microfabricated” or “microfluidic” generally refer to one or more fluid passages, chambers or conduits which have at least one internal cross-sectional dimension, e.g., depth, width, length, diameter, etc., that is less than 500 μm, and typically between about 0.1 μm and about 500 μm. In the devices of the present invention, the microscale channels or chambers preferably have at least one cross-sectional dimension between about 0.1 μm and 200 μm, more preferably between about 0.1 μm and 100 μm, and often between about 0.1 μm and 20 μm. Accordingly, the microfluidic devices or systems prepared in accordance with the present invention typically include at least one microscale channel, usually at least two intersecting microscale channels, and often, three or more intersecting channels disposed within a single body structure. Channel intersections may exist in a number of formats, including cross intersections, “T” intersections, or any number of other structures whereby two or more channels are in fluid communication. Body structures may be integrated structures, or may be aggregations of multiple separate parts that fit together to form the aggregate body structure.

Typically, the body structure of the microfluidic devices described herein comprises an aggregation of two or more separate layers which when appropriately mated or joined together, form the microfluidic device of the invention, e.g., containing the channels and/or chambers defined therein. Typically, the microfluidic devices described herein will comprise a top portion, a bottom portion, and an interior portion, wherein the interior portion substantially defines the channels and chambers of the device.

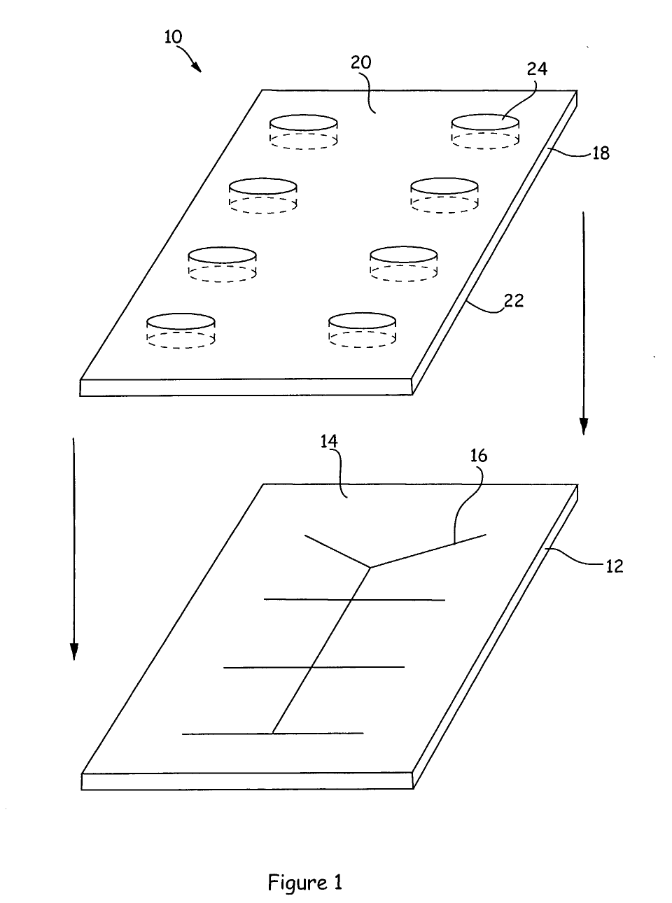

FIG. 1 illustrates a two-layer body structure 10, for a microfluidic device. In preferred aspects, the bottom portion of the device 12 comprises a solid substrate that is substantially planar in structure, and which has at least one substantially flat upper surface 14. A variety of substrate materials may be employed as the bottom portion. Typically, because the devices are microfabricated, substrate materials will be selected based upon their compatibility with known microfabrication techniques, e.g., photolithography, wet chemical etching, laser ablation, air abrasion techniques, injection molding, embossing, and other techniques. The substrate materials are also generally selected for their compatibility with the full range of conditions to which the microfluidic devices may be exposed, including extremes of pH, temperature, salt concentration, and application of electric fields. Accordingly, in some preferred aspects, the substrate material may include materials normally associated with the semiconductor industry in which such microfabrication techniques are regularly employed, including, e.g., silica based substrates, such as glass, quartz, silicon or polysilicon, as well as other substrate materials, such as gallium arsenide and the like. In the case of semiconductive materials, it will often be desirable to provide an insulating coating or layer, e.g., silicon oxide, over the substrate material, and particularly in those applications where electric fields are to be applied to the device or its contents. Although preferred substrates are planar in structure, it will be appreciated that a variety of substrate conformations may be utilized, including concave or convex structures, tubular structures, e.g., capillaries, and the like.

In additional preferred aspects, the substrate materials will comprise polymeric materials, e.g., plastics, such as polymethylmethacrylate (PMMA), polycarbonate, polytetrafluoroethylene (TEFLON™), polyvinylchloride (PVC), polydimethylsiloxane (PDMS), polysulfone, and the like. Such polymeric substrates are readily manufactured using available microfabrication techniques, as described above, or from microfabricated masters, using well known molding techniques, such as injection molding, embossing or stamping, or by polymerizing the polymeric precursor material within the mold (See U.S. Pat. No. 5,512,131). Again, these polymeric materials may include treated surfaces, e.g., derivatized or coated surfaces, to enhance their utility in the microfluidic system, e.g., provide enhanced fluid direction, e.g., as described in U.S. Pat. No. 5,885,470 which is incorporated herein by reference in its entirety for all purposes. Further, such alternate substrates may be in any of a variety of conformations, e.g., planar, tubular, concave, convex, or the like.

The channels and/or chambers of the microfluidic devices are typically fabricated into the upper surface of the bottom substrate or portion 12, as microscale grooves or indentations 16, using the above described microfabrication techniques. The top portion or substrate 18 also comprises a first planar surface 20, and a second surface 22 opposite the first planar surface 20. In the microfluidic devices prepared in accordance with the methods described herein, the top portion also includes a plurality of apertures, holes or ports 24 disposed therethrough, e.g., from the first planar surface 20 to the second surface 22 opposite the first planar surface.

The first planar surface 20 of the top substrate 18 is then mated, e.g., placed into contact with, and bonded to the planar surface 14 of the bottom substrate 12, covering and sealing the grooves and/or indentations 16 in the surface of the bottom substrate, to form the channels and/or chambers (i.e., the interior portion) of the device at the interface of these two components. The holes 24 in the top portion of the device are oriented such that they are in communication with at least one of the channels and/or chambers formed in the interior portion of the device from the grooves or indentations in the bottom substrate. In the completed device, these holes function as reservoirs for facilitating fluid or material introduction into the channels or chambers of the interior portion of the device, as well as providing ports for coupling controllers for directing movement of materials through and among the channels of the device e.g., pressures sources, electrical sources etc.

In many embodiments, the microfluidic devices will include an optical detection window disposed across one or more channels and/or chambers of the device. Optical detection windows are typically transparent such that they are capable of transmitting an optical signal from the channel/chamber over which they are disposed. Optical detection windows may merely be a region of a transparent cover layer, e.g., where the cover layer is glass or quartz, or a transparent polymer material, e.g., PMMA, polycarbonate, etc. Alternatively, where opaque substrates are used in manufacturing the devices, transparent detection windows fabricated from the above materials may be separately manufactured into the device.

These devices may be used in a variety of applications, including, e.g., the performance of high throughput screening assays in drug discovery, immunoassays, diagnostics, genetic analysis, and the like. As such, the devices described herein, will often include multiple sample introduction ports or reservoirs, for the parallel or serial introduction and analysis of multiple samples. Alternatively, these devices may be coupled to a sample introduction port, e.g., a pipettor, which serially introduces multiple samples into the device for analysis. Examples of such sample introduction systems are described in e.g., U.S. Pat. Nos. 5,880,071 and 6,046,056 each of which is hereby incorporated by reference in its entirety for all purposes.

II. Detection System

In general, detection of chemical or biochemical reactions involves light based detection of end products such as light absorbance, fluorescence, phosphorescence or the like. Generally, in the case of microfluidic systems, the detection systems are placed either within or proximal to the microfluidic device or one or more microchannels, microchambers, micro-reservoirs or conduits of the device, such that the detector is within sensory communication of the device, channel, reservoir, or chamber etc. The phrase “proximal” to a particular element or region, as used herein, generally refers to the placement of the detector in a position such that the detector is capable of detecting a property of the microfluidic device, a portion of the microfluidic device, or the contents of the portion of the microfluidic device. Typically, in operation, the detection system is oriented substantially perpendicular to the planar body structure of the device, e.g., as is conventionally done in microfluidic systems. The materials that are being analyzed using these systems, e.g., subjected to optical analysis for light based signals, are transported along a microscale channel, past a detection point, whereby a detectable signal indicative of the presence or absence of some material or condition, is measured. In the case of light based detection systems, the signals within these channels typically result from the presence of light emitting substances therein, e.g., fluorescent or chemiluminescent materials, that are used as indicators for the presence or absence of some material or condition.

Many different molecular/reaction characteristics can be detected in the devices of the current invention. As such, any number of detection methods may be employed for the different applications. In the case of optical detection systems, an optical property of a material within, e.g., the microchannels of the microfluidic devices, is measured. The present invention provides methods for positioning the detection system at a desired location, i.e. adjacent or proximal, to a microscale channel of a microfluidic device so that the detection system is in sensory communication with the channel via an optical detection window or zone that is disposed across the channel or chamber of the device.

Optical detection systems of the invention include, e.g., systems that are capable of measuring the light emitted from material within the channel, the transmissivity or absorbance of the material, as well as the material's spectral characteristics, e.g., fluorescence, chemiluminescence, etc. Detectors optionally detect a labeled compound, such as fluorogenic, colorimetric, and radioactive components. The various types of detectors optionally include spectrophotometers, photodiodes, avalanche photodiodes, microscopes, scintillation counters, cameras, diode-arrays, imaging systems, photomultiplier tubes, CCD arrays, scanning detectors, galvo-scanners, film and the like, as well as combinations thereof. Proteins, antibodies, or other components which emit a detectable signal can be flowed past the detector, or alternatively, the detector can move relative to an array to determine molecule position (or, the detector can simultaneously monitor a number of spatial positions corresponding to channel regions, e.g., as in a CCD array). Examples of suitable detectors are widely available from a variety of commercial sources known to persons of skill in the art. See, also, The Photonics Design and Application Handbook, books 1, 2, 3 and 4, published annually by Laurin Publishing Co., Berkshire Common, P.O. Box 1146, Pittsfield, AM for common sources for optical components.

The detection system of the systems and methods of the present invention can optionally comprise a number of different apparatuses. For example, fluorescence can be detected by, e.g., a photomultiplier tube (PMT), a charge coupled device (CCD), a photodiode, or the like. A photomultiplier tube is an optional aspect of the present invention. A photomultiplier tube converts light (photons) into an electronic signal. In a preferred embodiment of the present invention, the location of an optical feature of the device, is determined by a detection signal comprising a light signal which is converted into an electric signal by a photomultiplier tube. Typically, the magnitude of signal available for detection within the channels is extremely small due to the small dimensions of the microscale channels. For example, the power levels of signals from detection regions in a microfluidic channel of the devices of the present invention are about 0.1 pW to about 10 pW. A PMT therefore is a preferred detection means since it amplifies the detection of each photon into a larger and more easily measurable pulse of electrons. PMTs are commonly used in many laboratory applications and settings and are well known to those of skill in the art.

Another optional embodiment of the detection systems of the present invention comprises a charge coupled device. CCD cameras can detect even very small amounts of electromagnetic energy (e.g., such as that emitted by fluorophores in the present invention). CCD cameras are made from semi-conducting silicon wafers that release free electrons when light photons strike the wafers. The output of electrons is linearly directly proportional to the amount of photons that strike the wafer. This allows the correlation between the image brightness and the actual brightness of the event observed. CCD cameras are very well suited for imaging fluorescence emission since they can detect even extremely faint events, can work over a broad range of spectrum, and can detect both very bright and very weak events. CCD cameras are well known to those in the art and several suitable examples include those made by Stratagene (La Jolla, Calif.), Alpha-Innotech (San Leandro, Calif.), and Apogee Instruments (Tucson, Ariz.) among others.

Yet another optional embodiment of the detection systems of the invention comprises use of a photodiode to detect fluorescence from molecules in the microfluidic device. Photodiodes absorb incident photons which cause electrons in the photodiode to diffuse across a region in the diode thus causing a measurable potential difference across the device. This potential can be measured and is directly related to the intensity of the incident light.

Generally, the detection system measures an amount of light emitted from the material, such as fluorescent or chemiluminescent material. As such, the detection system of the present invention will typically include collection optics for gathering a light based signal transmitted through the detection window or zone, and transmitting the signal to an appropriate light detector (described in greater detail below). Microscope objectives of varying power, field diameter, and focal length are readily utilized as at least a portion of this optical train.

The detection system is typically coupled to a computer via an analog to digital or digital to analog converter, for transmitting detected light data to the computer for analysis, storage and data manipulation. One of the more common detection schemes employed in the systems of the present invention, is the measurement of light emitted from a fluorescent material such as labeled cells or fluorescent indicator dyes or molecules. In a typical operation of the microfluidic systems using fluorescence detection, a signal bearing sample material is transported along the microscale channel and past a detection point. In general the detection system includes at least one light source emitting light at one or more excitation wavelengths and a light detector for detecting one or more fluorescent wavelengths. In one embodiment, the sample is irradiated by two different sources, a laser emitting red light and an LED emitting blue light. Both sources operate in a continuous, rather than pulsed, mode. The sample fluoresces at multiple wavelengths when irradiated with light of the appropriate wavelength. Fluorescence from the sample is detected by a detector. The excitation light as well as the emitted fluorescence pass through a common lens assembly thereby creating a common beam path for both the excitation and the emission light. Filters are used both in conjunction with the source and with the detectors in order to minimize the background radiation falling on the detectors, thereby increasing the signal to noise ratio. The light detector is located proximal to a detection window along a microscale channel for detecting light based signals.

Typically, a detection system comprises a number of optical components including lens, lasers, LED, filters, a beam splitter and a microprocessor. The detection system can exist as a separate unit, but is preferably integrated with a controller system, into a single instrument. The controller system generally includes a motor for transporting the light source and the light detector across a device. Integration of these functions into a single unit facilitates connection of these instruments with a computer (described below), by permitting the use of few or a single communication port(s) for transmitting information between the controller, the detector and the computer. Integration of the detection system with a computer system typically includes software for converting detector signal information into information relating to the location of an optical feature of the device.

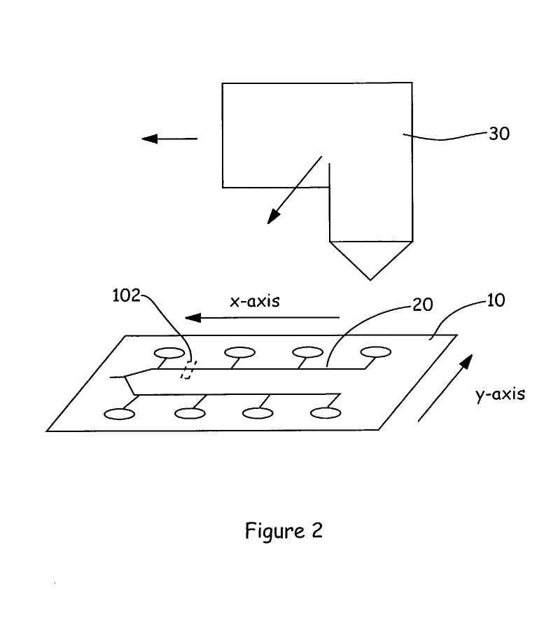

In operation, the devices and systems of the invention perform one or more analytical operations followed by detection of the results of the one or more operations within the detection channel region. FIG. 2 illustrates the use of a microfluidic device with a detector proximal to the detection window. The microfluidic device 10, comprises microscale channels 20 designed to handle small volumes of fluid. Materials to be analyzed are transported along the microscale channel, past a detection window/region (102), where a detectable signal indicative of the presence or absence of some material or condition is measured by detection system 30. The signals within these channels result from the presence of light emitting substances therein. The light emitting substances may be fluorescent or chemiluminescent materials, for example, which are used as indicators of the presence or absence of some material or condition. Detection system 30 is used to measure the amount of light emitted from the fluorescent or chemiluminescent material within the channels of a device.

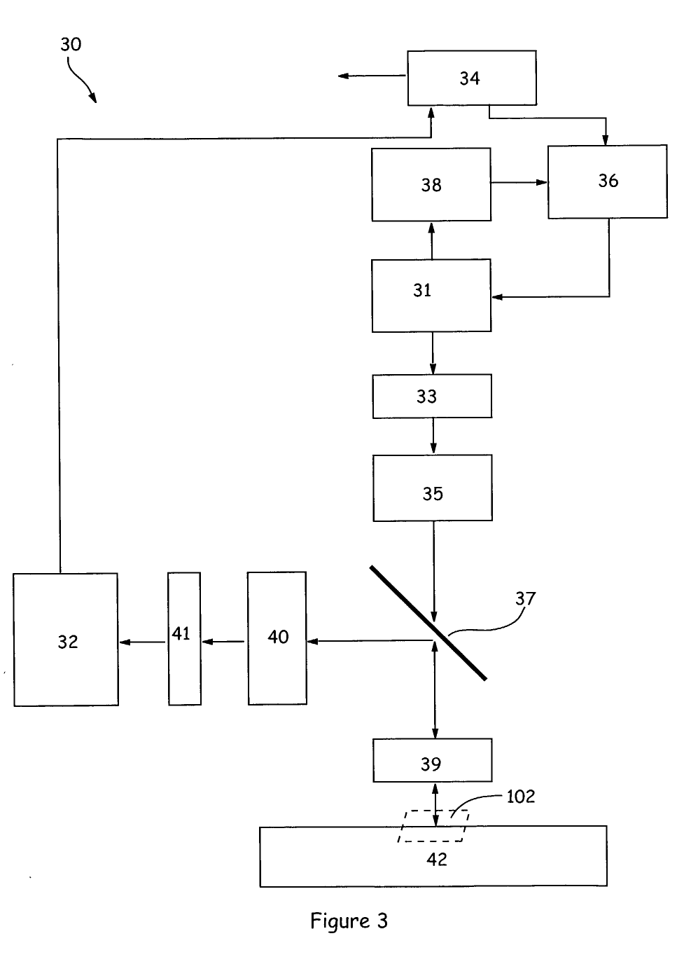

FIG. 3 shows a block diagram of an embodiment of a detection system used with the methods of the present invention. Detection system 30 may be used to detect fluorescence induced by exposure to laser radiation to generate a signal. As shown, detection system 30 includes a light source (e.g., laser or laser diode) 31 for emitting light towards a sample located within the microfluidic device 42, a light detector (e.g., fluorescent detector) 32 operable to detect light emitted from the sample and to convert the light into electric signals, and a microprocessor 34 for controlling the light source, decoding the electric impulses provided by the detector, and transmitting the decoded impulses to a host computer (not shown) as data. As described below, detection system 30 also includes a number of optical components including lasers, LED, filters, and a beam splitter for filtering light and directing the excitation light emitted from the light source 31 towards the sample, separating fluorescence light emitted from the sample from reflected excitation light and directing it towards the light detector 32. The light source of the detection system is positioned such that the detection region of the microchannel is disposed in an optical path of the light source 31 so that the system is in sensory communication with the microchannel via the optical detection window disposed across the microchannel at the detection region. The light source 31 is positioned at an appropriate distance for activating the fluorescent indicator within the test sample. As the sample passes the detection region 102, signals produced by the sample materials are detected by detector 32 and sent to microprocessor 34. The light source 31 preferably produces light at an appropriate wavelength for activating fluorescently labeled samples. For example, a red laser diode may be used as the light source in order to facilitate detection of fluorescent species that excite in the red range. Light source 31 may be any number of light sources that provide the appropriate wavelength, including lasers, laser diodes, light emitting diodes (LED), and the like. Also, light source 31 may be configured to produce a wavelength suitable for detecting materials other than those that are fluorescently labeled. When the light source 31 is cycled on by the microprocessor 34, the light emitted from the light source 31 passes through a lens 33 which focuses the light, and then through an emission filter 35. The emission filter 35 removes light with undesired wavelengths from the light source's emission band, primarily passing the wavelengths necessary to excite the selected fluorophores. For example, the emission filter may only allow light having a wavelength between 625 nm and 705 nm to pass therethrough.

After the light passes through emission filter 35, a portion of the light passes through a beamsplitter 37 mounted at a 45 degree angle of incidence to the incoming laser beam. Beamsplitter 37 passes the wavelengths necessary to excite the selected fluorophores while reflecting the undesirable wavelengths. For example, beamsplitter 37 further filters the light emitted from the light source by permitting only light with wavelength less than 670 nm to pass therethrough. The light that passes through the beamsplitter 37 impinges on the sample within the microfluidic device 42. A lens 39 is provided to focus the beam from the beamsplitter onto the sample. The fluorescence emitted from the sample travels back along the same optical path from the sample to the beamsplitter 37 and is reflected by the beamsplitter towards light detector 32. The beamsplitter filters the light by reflecting the fluorescence light while allowing the excitation light to pass therethrough. A dichroic coating is preferably placed on a surface of the beamsplitter 37 to filter the reflected excitation light from the fluorescence light. Beamsplitter 37 first directs the fluorescent light to a detection filter 40 which further filters the signal emitted from the sample. Detection filter 40 may be configured to allow only light having a wavelength between 645 nm and 665 nm to pass through, for example. The emission and detection filters 35, 40 may be filters available from Omega Optical, Inc. of Brattleboro, Vt., for example. A focusing lens 41 is disposed adjacent detection filter 40 to direct the light reflected from beamsplitter 37 into light detector 32.

Light detector converts the incoming light into electric impulses. These electrical impulses are decoded by the microprocessor 34 and sent to the host computer as data. Detection system 30 is preferably coupled to the host computer via a serial data connection, for transmitting detected light data to the computer for analysis, storage, and data manipulation. The light detector 32 may be a photodiode, avalanche photodiode, photomultiplier tube, diode array, or imaging systems, such as charged coupled devices (CCDs), and the like. Light detector 32 may include for example, an integrator and an analog-to-digital converter having analog input coupled to an output of the integrator, as described in U.S. patent application Ser. No. 09/104,813, filed Jun. 25, 1998 which is incorporated herein by reference.

Although the above description is made with reference to a microfluidic device, one of skill in the art will appreciate that the device could be any other suitable device such as a test tube, capillary tube, a microchannel, or well in a multiwell plate.

III. Methods of Alignment of Detection Optics

As stated above, the methods of the present invention provide a method for aligning optical components of a microfluidic system. Specifically, the methods provide positioning a detection system in reference to a device such that a signal emitted from a reaction within the device may be detected. In a broad sense, the method for aligning the detection system includes positioning a light beam on a surface of a device, collecting reflected light by a light detector, converting the light signal into data which is further translated into the location of a first optical feature of a device. The methods further provide repeating the steps outlined above to determine the location of a second optical feature of the device, determining the distance between the first and the second optical features of the device, followed by comparing this distance to a preprogrammed layout of the device to compute the precise location of the light detector in reference to the device. Finally, the methods provide transporting the detection system to the targeted region of the device.

Typically, the targeted region may be a detection window disposed over a microchannel of a microfluidic device. The light source generates a light beam that travels through a lens, which focuses the light into an optical beam incident on a surface of the device. A controller moves the detection system in a plane parallel to the surface of the device. As the optical beam travels the surface of the device, light reflected off the surface is directed back to the light detector within the detection system to create a background signal. A detectable signal is generated as the light beam coincides with an optical feature of the device. As used herein, an “optical feature” comprises a cavity, a channel, a reservoir or any other feature that yields a perturbation in the signal that is above a threshold level indicating a difference from the surface on which it is disposed. Suitable detectable signals for the methods of the present invention include essentially any change in the signaling characteristics received from the surface that comprises the optical features. For example, the detectable signal optionally includes a light emission, a change in light emission, an absorbance, a change in absorbance, a fluorescence, a change in fluorescence, a phosphorescence, a change in phosphorescence, a luminescence, a change in luminescence, a refractive index, refraction, diffraction or the like. In preferred aspects, a light detector such as a photodiode, a photo multiplier tube, and the like, converts the light signals into electrical signals. The electrical signals are decoded by a microprocessor within the detection system and transmitted to a host computer as data.

In the methods of the present invention, the detection system collects signals from at least two optical features of the device. The detection signals received from each of the at least two optical features are transmitted to a microprocessor for converting into electrical signals. The electrical signals are then directed to a host computer for computing the distance between the optical features. Generally, the distance between any two optical features of the device may be computed or measured by a number of different methods. In preferred aspects, the distance is computed by inputting the speed of travel of the optical beam, the time for the optical beam to travel between the two features and the diameter of the illumination spot that is created when the optical beam coincides with the surface of the device. It will be understood by one of skill that any other suitable method for measuring the distances between the optical features may be used within the present invention. The distance between the at least two optical features is compared to a preprogrammed configuration in order to determine the exact location of the light source in reference to the device. The detection module is then motioned along an axis perpendicular to the distance between the two optical features until the measured distance between the two optical features is equal to a pre set distance. When the detection module arrives at a distance equal to the preset distance, it is properly aligned with the targeted region of the device. In operation, measurement of the distance between the two points is carried out by system software having one or more logic instructions that direct the system to: (a) receive inputted parameters to travel the optical beam across the surface of the device at a given speed (b) measure the amount of time for the beam to move from the first optical feature to the next optical feature (c) receive inputted parameters for an illumination spot created when the optical beam is incident on the surface and (d) calculate the distance between the two points from the amount of time, the speed, and the width of the illumination spot. The methods of measurement of distances between the various optical features are described in detail in co-owned Application, Attorney Docket No. 100/13300 file Apr. 18, 2001, which is incorporated in its entirety herein.

Generally, the microfluidic devices of the present invention are placed within an instrument module. The configuration of the instrument may be such that in certain embodiments the detection module is positioned above the microfluidic device while in some other embodiments the detection module is positioned below the microfluidic device. For example, in the Agilent 2100 Bioanalyzer instrument commercially available from Agilent Technologies (Palo Alto, Calif.), the detection module is generally disposed below the microfluidic device.

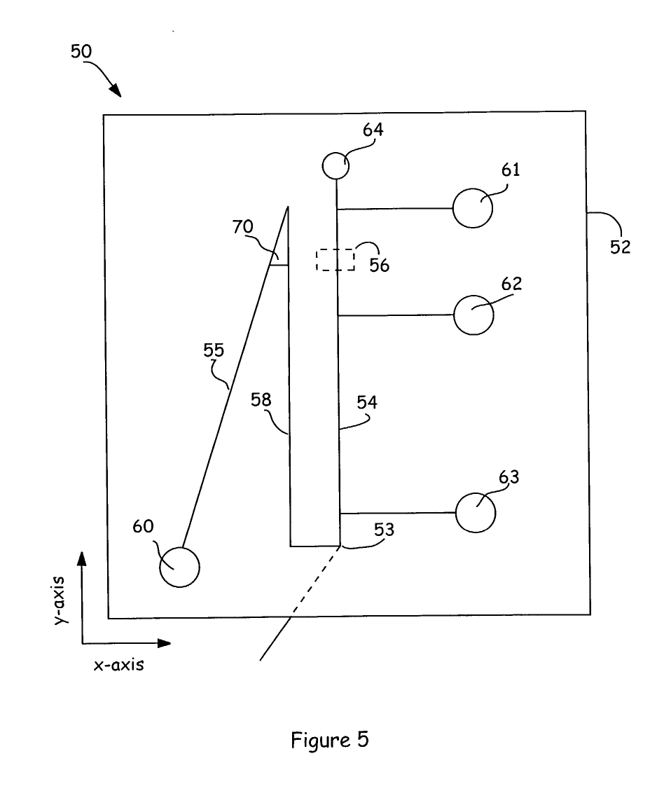

FIG. 5 provides additional details regarding an example microfluidic device that is optionally used to practice the methods herein. As shown the body structure 52 of the microfluidic device 50 has a reaction channel 54 and an alignment channel 55 therein. Reaction channel comprises a detection region 56 downstream from the sample introduction intersection 53. Reservoirs 60, 61, 62 and 63 are in fluid communication with the reaction channel 54 and the alignment channel 55. Alignment channel 55 continues into channel region 58 which is equal in length to the reaction channel 54. Microchannel region 58 runs parallel to reaction channel 54. Reaction components such as cells, reagents or dyes and/or other materials are flowed through the channels by applying a vacuum at reservoir 64 (or any other reservoir in the system) and/or by applying appropriate voltage gradients.

By way of example and in reference to FIG. 5, a solution comprising an intercalating dye is added into reservoir 60 and is flowed through the alignment channel 55 and the reaction channel. An optical detection system is scanned along the surface of the microfluidic device such that an optical beam generated by the light source within the detection system, travels along the X-axis. When the optical beam is incident on the surface of the body structure, it is reflected back and detected by a light detector such as a photodiode. The signal obtained from the light reflected off the surface forms a threshold or background signal. As the traveling light beam reaches an optical feature, such as the alignment channel 55, the change in the intensity of the reflected light generates a detectable signal. This is recorded as a first signal. When the light beam reaches the microchannel region 58, a second signal is recorded. The computer computes the distance traveled between the first and the second signals. The measured distance is then compared using an algorithm to a stored library of various optical layouts, e.g., to known distance 70 which is calculated along an axis of the device that includes the detection region 56. Based on the measured distance, a controller controls the detection system and motions it along the Y-axis, and then the above steps are repeated, e.g., the distance between the alignment channel 55 and the microchannel 58 is again calculated at this next position along the Y-axis, and the measured distance then compared to the known distance 70 between the channels 55, 58. These steps are iteratively repeated one or more times until the detection system reaches a point where the measured distance is equal to distance 70. At this location, the detection system is motioned along the X-axis until it reaches a third optical feature, i.e. detection region 56.

The arrangement of channels depicted in FIG. 5 is merely one possible arrangement of the spatial positioning of the various microchannels and reservoirs. Of course, any arrangement that is appropriate for use with the features of the above-described method may be used in the present invention. Additional alternatives can be devised, e.g., by combining the microfluidic elements described herein with other microfluidic device components described in the patents and applications referenced herein.

IV. Method of Identifying a Microfluidic Device

The present invention also provides methods and systems for identifying a microfluidic device. In one aspect, the invention provides a method of obtaining an optical profile of a microfluidic device whereby a light detector traveling in a plane parallel to a surface of a device detects various optical features disposed on the surface. The detection signals received from each of the optical features are transmitted to a microprocessor for converting into electrical signals. The electric signals are then directed to a host computer for creating and storing an optical profile of the device.

In another aspect of the invention, the systems of the present invention comprise a host computer and software for storing and comparing the design configuration of the various optical features of a given device.

In yet another aspect, the methods of the present invention provide identifying a device by comparing an optical profile of the device with a library of preprogrammed profiles of various devices. A detection module scans a surface of the device to image the optical profile of the device. As previously described, detection signals are generated when the light beam coincides with the various optical features of the device. A detection signal is received for each optical profile scanned. The detection signal is transmitted to a microprocessor with decodes the signal and communicates the information to a host computer. The host computer stores a library of known optical profiles for multiple devices. The optical profile for a given device is compared with the library of stored profiles. An exact match of the detected profile with a member of the library is used to identify the device.

A preferred embodiment of the method is as follows: A microfluidic device is placed in an instrument such as the Agilent 2100 Bioanalyzer. Generally, the device is placed in a fixed location within the device. Optionally, based on the detection system employed, a detectable material is flowed through the microscale network of the device. The system is programmed with software including logic instructions to (a) direct the system controller to motion the optical detection system to travel from the left to the right along the X-axis (b) detect and store signals from light reflected back from the surface of the device (c) compare the profile of the device with a library of stored profiles (d) identify the exactly matching profile within the stored library.

Although, the above method has been described in regards to a microfluidic device, it will be appreciated that a scan pattern may be obtained for other devices also.

V. Systems for Alignment of Detection Optics

### A. Computer

The systems of the invention include integrated software and hardware systems for performing the various methods of the invention. In particular, the systems includes a computer and system software having one or more logic instructions. The logic instructions direct the system to (a) receive and store input pertaining to optical profiles of devices (b) control the detection system to travel in relation to a device so as to pass an optical beam along the surface of the device (c) receive and store detection signals created as the optical beam coincides with multiple optical features of the device (d) calculate the distance traveled between two detection signals (e) compare the calculated distance with a stored optical profile and (f) relocate the detection system to travel to a targeted region of a device. Alternatively, the system software has additional logic instructions to identify a selected device by repeating steps (a) through (d) above, and further to identify a given device by comparing the optical profile to a library of stored optical profiles.

The following example illustrates a typical calculation performed in step (d) above to determine the location of a detection region in reference to a surface of the device.

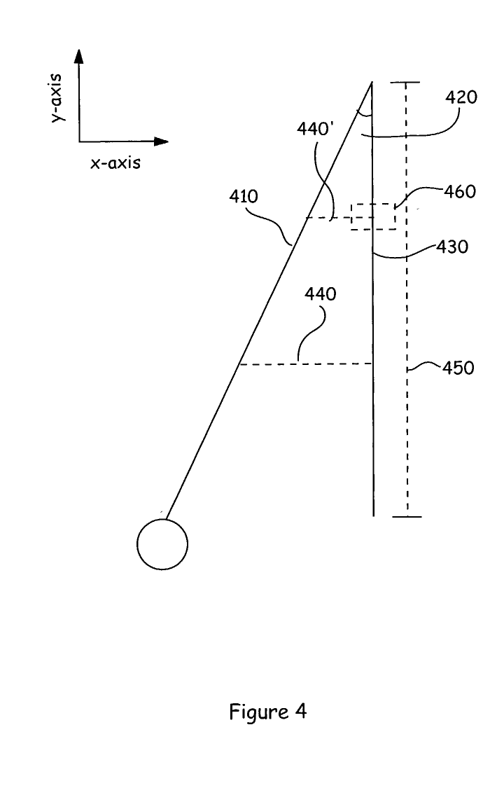

FIG. 4 illustrates an embodiment of a layout of optical features of a microfluidic device. The alignment channel 410 forms an angle 420 with the detection channel 430. The detection system sweeps along the x axis to measure the distance 440 between the channels 410 and 430.

The calculation of the distance is based upon the equations shown below:

Tan (420)=Distance 440/Distance 450

Distance 440=Distance 450×Tan (420)

The measured distance 440 is used to determine the location of the light detector in reference to the channel 430. The light detector is then motioned along the y axis until the measured distance 440 is equal to the distance 440′. When the measured distance is equal to 440′, the light detector coincides with the detection region 460.

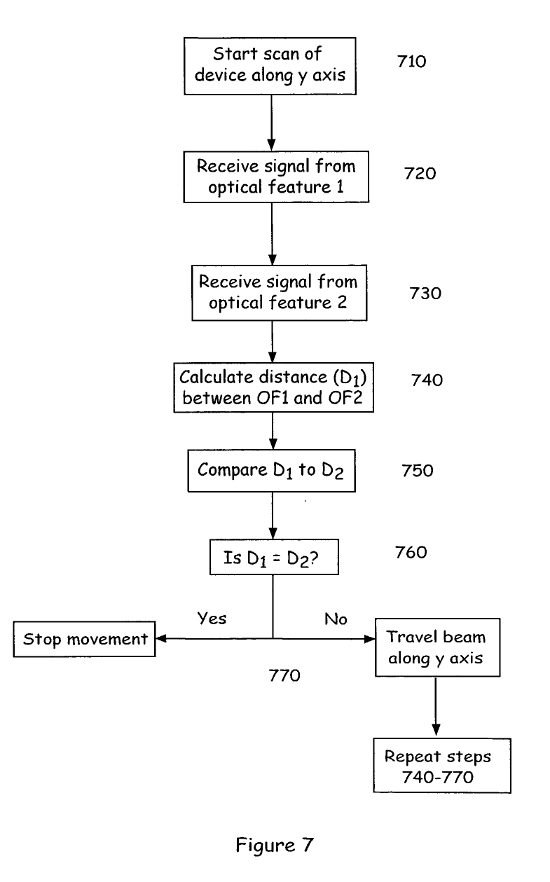

FIG. 7 is a flow chart that further schematically shows steps carried out by the computer for performing some of the methods described herein. As shown, the programmed process beings at step 710, where the computer starts the scan of the device along the x axis (e.g. as shown in FIG. 2). In step 720, the computer receives and stores the detection signal for the first optical feature. In step 730, the computer then directs the controller to continue to move the detection system until a second optical feature is detected. Again, at step 730, the computer receives and stores the detection signal for the second optical feature. In step 740, the distance between the two optical features is calculated according to the equations described herein. At step 750, the measured distance is compared with a preprogrammed distance. At this point, in step 760, if the distance is equal to the preprogrammed distance the computer instructs the controller to stop the motion of the detection system or on the other hand if the measured distance is not equal to the preprogrammed distance, then in step 770 the computer instructs the system to transport the detection system along the y axis until the measured distance between optical feature 2 and optical feature 1 is equal to the preprogrammed distance.

As noted above, the systems of the present invention typically involve additional elements. For example, overall microfluidic systems also typically employ a fluid direction and control system that causes and directs the flow of fluids within the microfluidic channel networks. Such flow control systems are preferably, a combination of a pressure controller system, e.g., a pressure or vacuum source applied to one or more ports in the channel network, as well as a channel network configuration that is optimized to yield a particular flow profile under the applied pressure differentials in the system. For example, in some preferred cases, a single vacuum source is applied to one port in a microfluidic channel network. Relative flow rates of materials in all of the various channels is then controlled by the designed flow resistance of the channels of the device. In alternate methods, multiple pressure and/or vacuum sources are applied to a plurality of different ports of the device to regulate pressure differentials across different channels of the device at different times, to control the flow profiles within the device. Such multiport pressure controllers are described in, e.g., U.S. patent application Ser. No. 60/216,793, filed Jul. 7, 2000, and incorporated herein by reference in its entirety for all purposes.

In alternative embodiments, the devices of the invention employ electrokinetic material direction systems. Electrokinetic systems typically operate by applying electric fields through channels in order to cause the movement of materials through those channels. Electrokinetic movement can include one or both of electrophoresis and electroosmosis.

Electrokinetic material direction systems in microfluidic channel networks typically include electrodes placed at the termini of the various channels of the channel network, e.g., at reservoirs or ports disposed at those unintersected termini. Each electrode is then coupled to one or more power supplies that deliver controlled electrical currents through the channels of the device to drive the movement of material either through electrophoresis or electroosmosis. Examples of such systems include the Agilent 2100 Bioanalyzer and associated Caliper LabChip® microfluidic devices. Electrokinetic control of material movement in microfluidic channel networks has been described in detail in, e.g., U.S. Pat. Nos. 5,588,195 and 5,976,336, each of which is incorporated herein by reference for all purposes. Generally, such systems employ pin electrodes that contact fluid filled reservoirs at the termini of the channels, to deliver electrical current through the various channels of the network. By controlling the amount, duration and channels through which current is applied, one can precisely control the direction and velocity of material movement through those channels. Alternatively, electrical circuits are included on the microfluidic device and are interfaced with controllers via one or more slide connectors. These instruments can be readily configured to operate in accordance with the present invention, e.g., by including an improved channel network such as those described herein, interfaced with the controller-detector instrument.

### EXAMPLES

### I. Example

Optical Profile for various Caliper LabChip® microfluidic devices used with the Agilent 2100 Bioanalyzer.

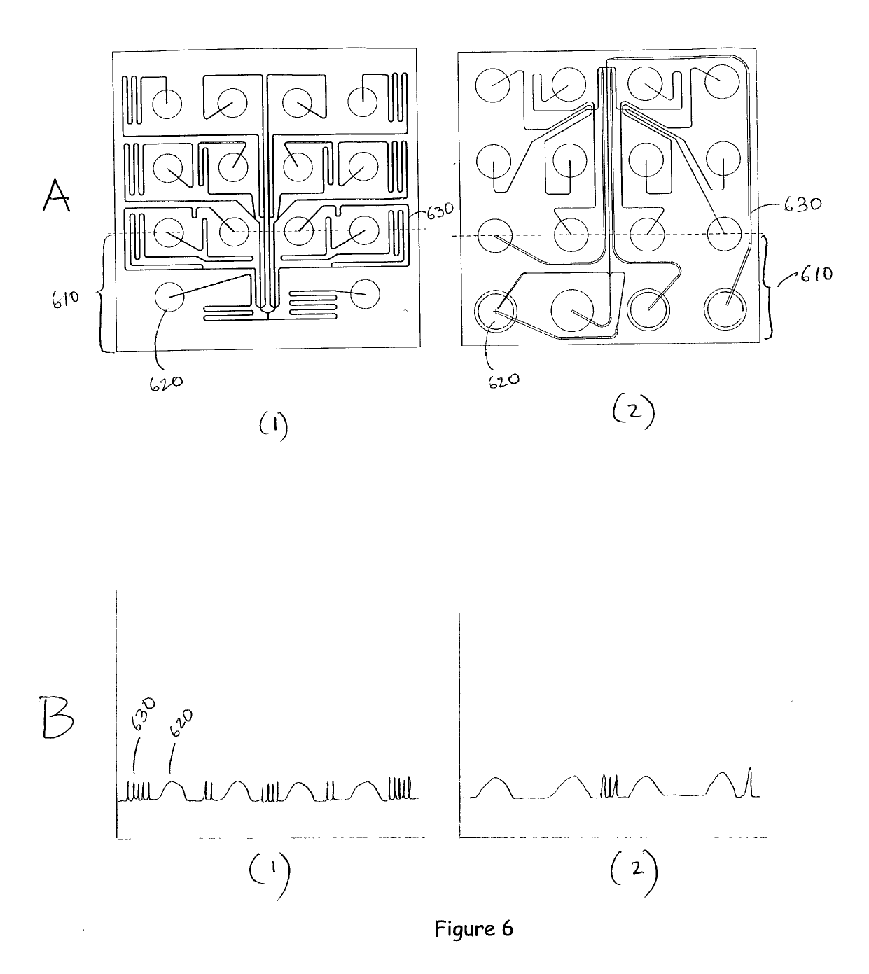

FIG. 6 illustrates optical profiles obtained for two different microfluidic devices used with the 2100 Bioanalyzer. Each of the devices is mounted on a caddy. The BioAnalzyer is designed to place the caddy in a fixed position. The caddy comprises holes which allow the user to position the caddy on a couple of locator pins on a platform within the instrument. During the operation of the instrument, the microfluidic device remains stationary. The detection system is located underneath the device. By virtue of the fixed position of the device, the detector scans across the device at a fixed distance 610 from the outer edge of the device. This is illustrated by the dotted line across the devices shown in Panel A. As shown the optical profile for each of the devices is unique and therefore different from those of the other devices. As described herein, the computer is programmed to store a library of patterns or optical profiles for each device. The devices are identified by comparing the pattern of the signal profile with the library of stored patterns representing several optical features of the devices.

In the present example, a buffer solution containing an intercalating dye such as Cy5™ was flowed through all the microfluidic elements of the devices. A fluorescent detection system was employed. The detection system scanned across the devices at a fixed distance from the outer edge of the device. The dotted line illustrates the path of the detection system scan relative to the device. The back reflected light was detected and converted into electrical signal to obtain the signature optical profiles for each microfluidic device. As shown, reservoirs 620 appear as very broad peaks while the microchannels 630 of the devices appear as sharp peaks.

While the foregoing invention has been described in some detail for purposes of clarity and understanding, it will be clear to one skilled in the art from a reading of this disclosure that any number of changes in form and detail can be made without departing from the true scope of the invention. For example, all the methods and apparatuses described above may be used in various combinations. All publications, patents, patent applications or other documents cited in this application are incorporated by reference in their entirety for all purposes to the same extent as if each individual publication, patent, patent application, or other document were individually indicated to be incorporated by reference for all purposes.

What is claimed is:

1. A method of positioning an optical detection system with respect to a detection region of a microfluidic device, comprising:
a) positioning a light beam at a first position along a first axis of said device;
b) moving the light beam along the first axis through said first position to detect a first optical feature of the device;
c) moving the light beam along the first axis to detect a second optical feature of the device;
d) determining a first distance between the first and second optical features of the device;
e) comparing the first distance to a preset distance between the first and second optical features of the device; and
f) moving the light beam to a second position along a second axis of said device if the measured distance is not equal to the preset distance between the first and second optical features.

2. The method of claim 1, wherein the first and second optical feature comprises first and second microfluidic channels.

3. The method of claim 1, wherein said first axis comprises an X-axis of the device.

4. The method of claim 1 wherein said first axis comprises a Y-axis of the device.

5. The method of claim 1, further comprising repeating steps (a) through (e) until the first distance is equal to the preset distance between the first and second optical features of the device.

6. The method of claim 1 wherein said detection region is located along an axis of the device along which said preset distance between said first and second optical features is calculated.

7. The method of claim 2, wherein the first and second microfluidic channels comprise a reaction channel and an alignment channel.

8. The method of claim 5 further comprising moving the light beam to a position at which the measured distance between the first and second optical features is equal to the preset distance between the optical features.

9. The method of claim 3 wherein moving the light beam to a second position comprises moving the light beam along a Y-axis of the device which is perpendicular to said first axis.

10. A method for identifying a microfluidic device, comprising:
providing a microfluidic device with a first pattern of microchannels and reservoirs;
obtaining a first optical profile of the microfluidic device, said optical profile reflecting the first pattern;
comparing the first optical profile to a library of patterns.

11. The method of claim 10 wherein the first optical profile comprises channel geometry on the microfluidic device.

12. The method of claim 10 wherein the first optical profile comprises at least two microfluidic channels

13. The method of claim 10 wherein the first optical profile comprises at least one microfluidic channel and at least one reservoir.

14. The method of claim 10 wherein obtaining the first optical profile comprises imaging an area of the microfluidic device.

15. The method of claim 14 wherein imaging an area of the microfluidic device comprises taking a digital picture of a region of the microfluidic device.

16. The method of claim 1 wherein said determining is performed by a computer.

17. The method of claim 16 wherein said computer stores the preset distance between the first and second optical features.

18. The method of claim 8 further comprising moving the light beam to a third optical feature which includes the detection region.

19. The method of claim 18 wherein the third optical feature comprises a microfluidic channel of the device.
